(19) United States
(12) Patent Application Publication
(10) Pub. No.: US 2016/0277860 A1
(43) Pub. Date: Sep. 22, 2016

(54) Apparatus, Method and Computer Program for Providing an Audio Signal

(71) Applicant: Nokia Technologies Oy, Espoo (FI)

(72) Inventors: Sampo Vesa, Helsinki (FI); Matti S. Hamalainen, Lempaala (FI); Riitta E. Vaananen, Helsinki (FI); Jussi Ramo, Espoo (FI); Vesa Valimaki, Espoo (FI)

(21) Appl. No.: 15/068,878

(22) Filed: Mar. 14, 2016

(30) Foreign Application Priority Data
Mar. 18, 2015 (GB) 1504548.7

(51) Int. Cl. H04R 29/00; H04R 1/10; H04R 3/04

(52) U.S. Cl. CPC H04R 29/001; H04R 3/04; H04R 1/1016; H04R 1/1041; H04R 2460/15

(57) ABSTRACT

A method, apparatus and computer program, the method comprising: obtaining information relating to a measured response of a headphone wherein the response is measured when the headphone is positioned adjacent an ear canal of a user; obtaining information relating to a target response of the headphone wherein the target response replicates a different headphone; determining at least one filter using the measured response and the obtained information relating to the target response; and enabling the at least one filter to be applied to an audio signal to obtain the target response.

### TECHNOLOGICAL FIELD

Examples of the disclosure relate to an apparatus, method and computer program for providing an audio signal. In particular they relate to an apparatus, method and computer program for providing an audio signal using headphones.

### BACKGROUND

Headphones which provide acoustic signals and are designed to be worn by a user are well known. Such headphones could be in-ear head phones which are positioned within the user's ear or headsets which are worn on the users head or any other type of headphones.

The sound quality which is produced by the headphones may vary between headphones. It is useful to enable high quality sound to be provided from different types of headphones.

### BRIEF SUMMARY

According to various, but not necessarily all examples of the disclosure, there may be provided a method comprising: obtaining information relating to a measured response of a headphone wherein the response is measured when the headphone is positioned adjacent an ear canal of a user; obtaining information relating to a target response of the headphone wherein the target response replicates a different headphone; determining at least one filter using the measured response and the obtained information relating to the target response; and enabling the at least one filter to be applied to an audio signal to obtain the target response.

In some examples a microphone may be provided within the headphone to enable the response of the headphone to be measured. The microphone may be adjacent to a speaker element within the headphone. The response of the headphone may be measured by providing a test signal from the headphone speaker element and using the microphone to record the response.

In some examples the response of the headphone may be measured whenever the headphone is used to enable the filters to be designed.

In some examples the measured response may be stored in memory circuitry and retrieved from the memory circuitry to enable the at least one filter to be determined.

In some examples information relating to the response of the user's ear canal may be obtained using a simulation ear canal.

In some examples the method may further comprise storing the at least one determined filter.

According to various, but not necessarily all examples of the disclosure, there may be provided an apparatus comprising: processing circuitry; and memory circuitry including computer program code, the memory circuitry and the computer program code configured to, with the processing circuitry, enable the apparatus to perform; obtaining information relating to a measured response of a headphone wherein the response is measured when the headphone is positioned adjacent an ear canal of a user; obtaining information relating to a target response of the headphone wherein the target response replicates a different headphone; determining at least one filter using the measured response and the obtained information relating to the target response; and enabling the at least one filter to be applied to an audio signal to obtain the target response.

In some examples a microphone may be provided within the headphone to enable the response of the headphone to be measured. The microphone may be adjacent to a speaker element within the headphone. The response of the headphone may be measured by providing a test signal from the headphone speaker element and using the microphone to record the response.

In some examples the response of the headphone may be measured whenever the headphone is used to enable the filters to be designed.

In some examples the measured response may be stored in memory circuitry and retrieved from the memory circuitry to enable the filters to be designed.

In some examples information relating to the response of the user's ear canal may be obtained using a simulation ear canal.

In some examples the apparatus may be further configured to store the at least one determined filter.

According to various, but not necessarily all examples of the disclosure, there may be provided a computer program comprising computer program instructions that, when executed by processing circuitry, enable: obtaining information relating to a measured response of a headphone wherein the response is measured when the headphone is positioned adjacent an ear canal of a user; obtaining information relating to a target response of the headphone wherein the target response replicates a different headphone; determining at least one filter using the measured response and the obtained information relating to the target response; and enabling the at least one filter to be applied to an audio signal to obtain the target response.

According to various, but not necessarily all examples of the disclosure, there may be provided a computer program comprising program instructions for causing a computer to perform the methods described above.

According to various, but not necessarily all examples of the disclosure, there may be provided a physical entity embodying the computer program as described above.

According to various, but not necessarily all examples of the disclosure, there may be provided an electromagnetic carrier signal carrying the computer program as described above.

According to various, but not necessarily all, examples of the disclosure there may be provided examples as claimed in the appended claims.

### BRIEF DESCRIPTION

For a better understanding of various examples that are useful for understanding the detailed description, reference will now be made by way of example only to the accompanying drawings in which:

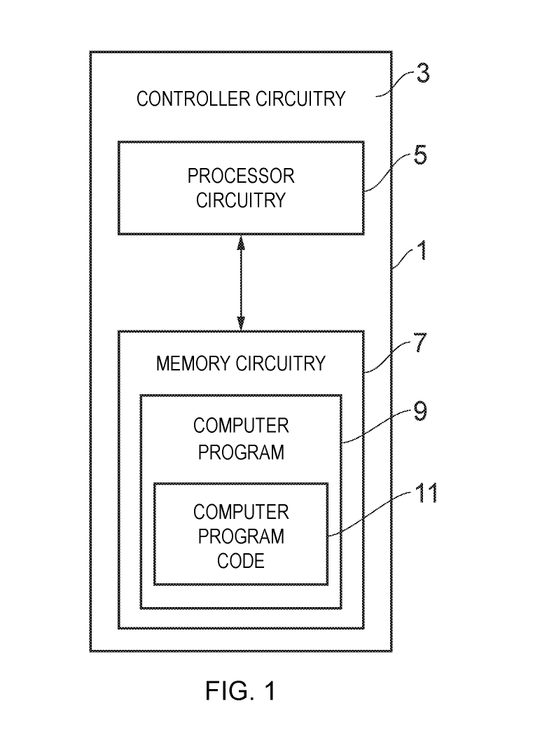

FIG. 1 illustrates an apparatus;

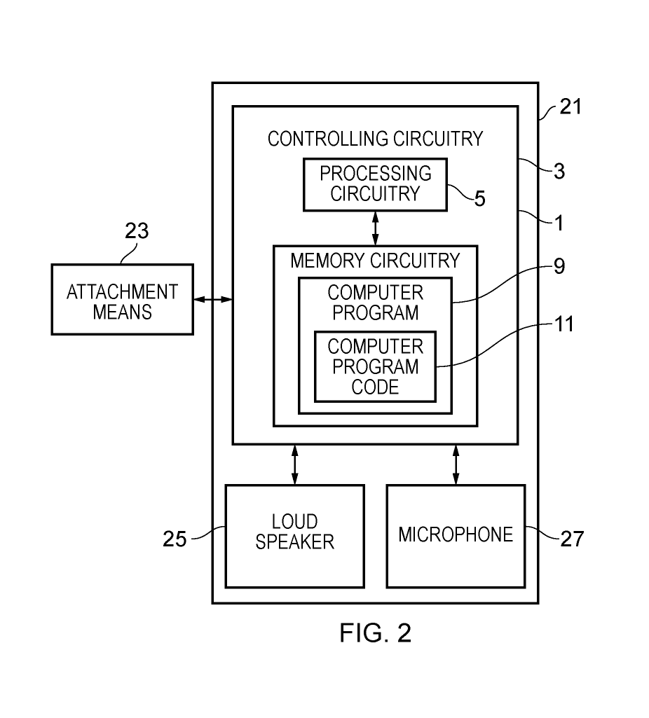

FIG. 2 illustrates an electronic device comprising an apparatus;

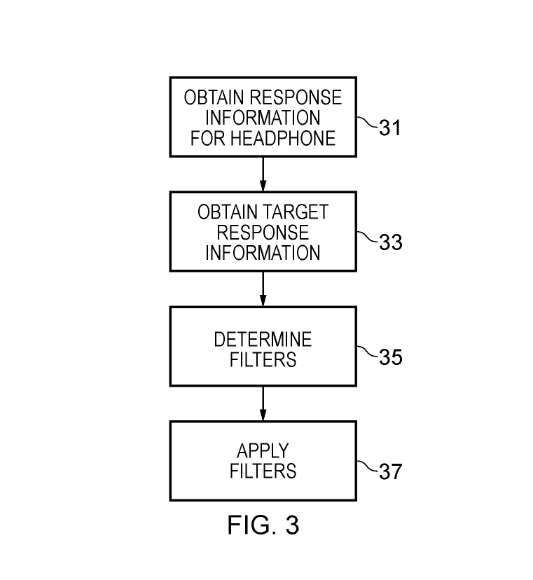

FIG. 3 illustrates a method;

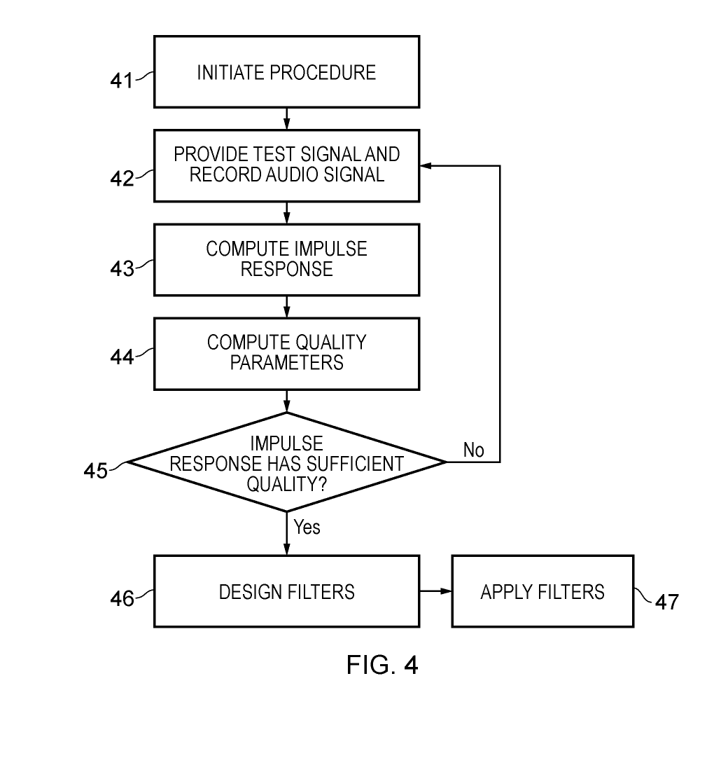

FIG. 4 illustrates another method;

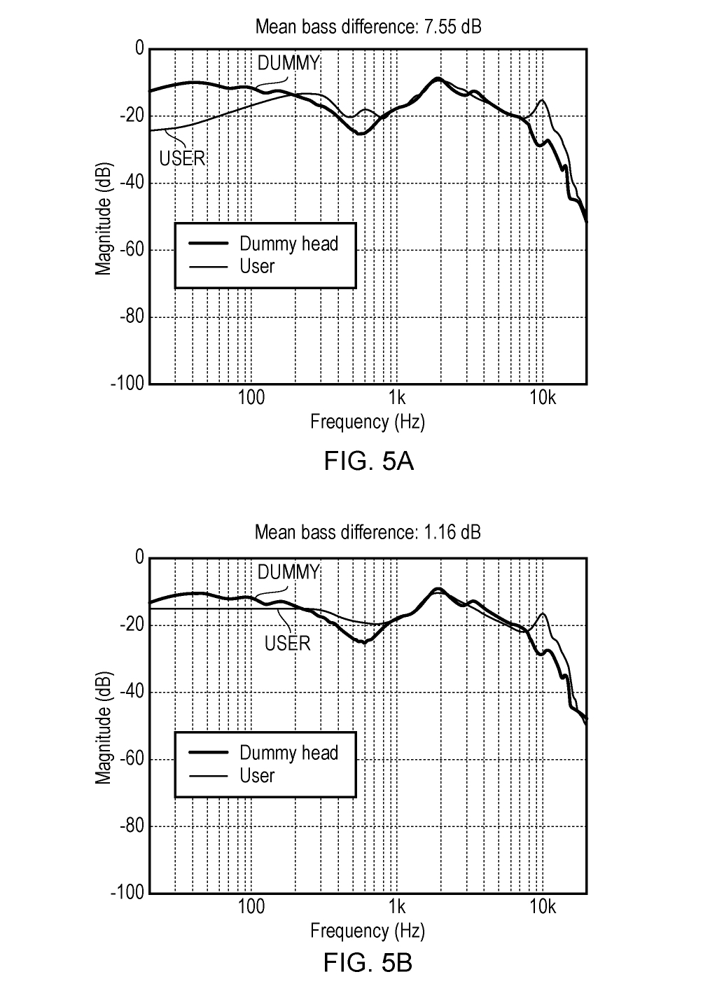

FIGS. 5A and 5B show plots of mean bass difference;

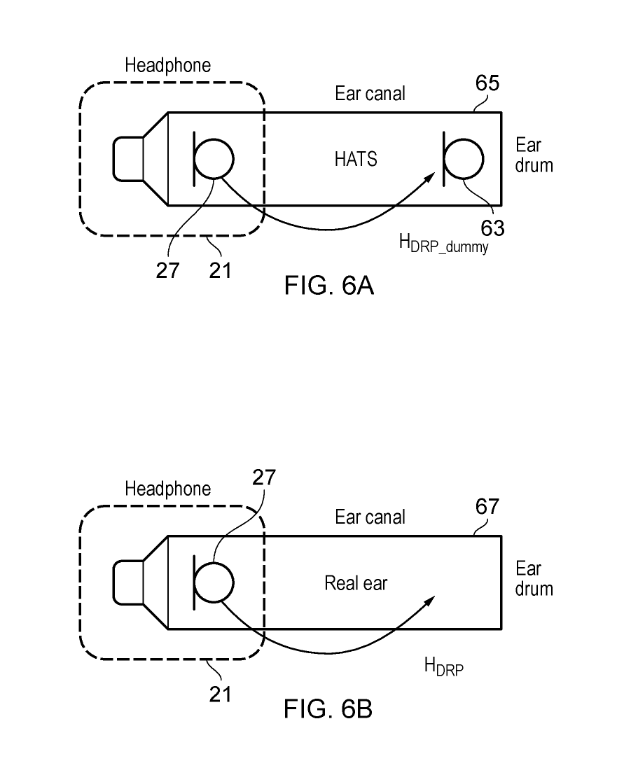

FIGS. 6A and 6B schematically illustrate a dummy head and a user's head;

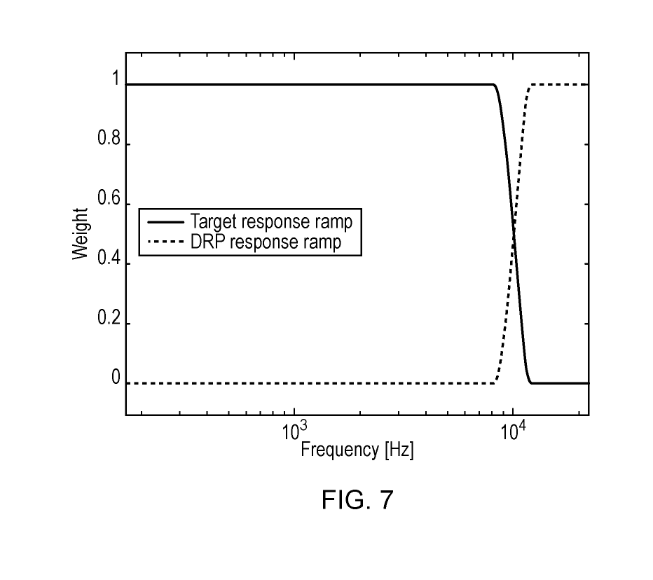

FIG. 7 shows a plot of weighting functions; and

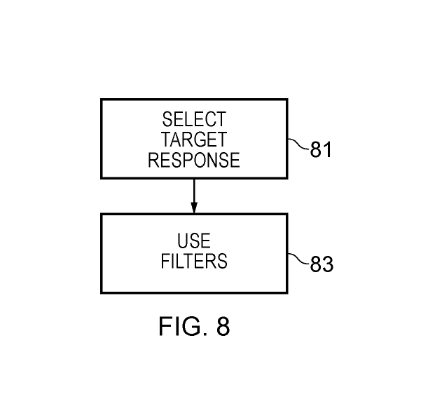

FIG. 8 illustrates another method.

### DETAILED DESCRIPTION

The Figures illustrate example methods, apparatus 1 and computer programs 9. The method comprises: obtaining 31 information relating to a measured response of a headphone wherein the response is measured when the headphone is positioned adjacent an ear canal 67 of a user; obtaining 33 information relating to a target response of the headphone wherein the target response replicates a different headphone; determining 35 at least one filter using the measured response and the obtained information relating to the target response; and enabling 37 the at least one filter to be applied to an audio signal to obtain the target response.

The apparatus 1 may be for providing an audio signal. The apparatus 1 may be provided within a headphone.

Examples of the disclosure may enable filters for an audio signal of a headphone to be designed to compensate for both the response of the headphone when it is worn by the user. This may enable a first headphone to be used to replicate the sound quality of a second different headphone.

FIG. 1 schematically illustrates an example apparatus 1 which may be used in implementations of the disclosure. The apparatus 1 illustrated in FIG. 1 may be a chip or a chip-set. In some examples the apparatus 1 may be provided within a device 21 such as headphones or other wearable device. In some examples the apparatus 1 could be provided within a user electronic device such as mobile phone or other portable device.

The example apparatus 1 comprises controlling circuitry 3. The controlling circuitry 3 may provide means for controlling an electronic device. For instance, where the apparatus 1 is provided in a headphone the controlling circuitry may provide means for controlling the output of a loudspeaker. The controlling circuitry 3 may also provide means for performing the methods or at least part of the methods of the disclosure.

The processing circuitry 5 may be configured to read from and write to memory circuitry 7. The processing circuitry 5 may comprise one or more processors. The processing circuitry 5 may also comprise an output interface via which data and/or commands are output by the processing circuitry 5 and an input interface via which data and/or commands are input to the processing circuitry 5.

The memory circuitry 7 may be configured to store a computer program 9 comprising computer program instructions (computer program code 11) that controls the operation of the apparatus 1 when loaded into processing circuitry 5. The computer program instructions, of the computer program 9, provide the logic and routines that enable the apparatus 1 to perform the example methods illustrated in FIGS. 3, 4 and 8. The processing circuitry 5 by reading the memory circuitry 7 is able to load and execute the computer program 9.

The apparatus 1 therefore comprises: processing circuitry 5; and memory circuitry 7 including computer program code 11, the memory circuitry 7 and the computer program code 11 configured to, with the processing circuitry 5, cause the apparatus 1 at least to perform: obtaining 31 information relating to a measured response of a headphone wherein the response is measured when the headphone is positioned adjacent an ear canal 67 of a user; obtaining 33 information relating to a target response of the headphone wherein the target response replicates a different headphone; determining 35 at least one filter using the measured the response and the obtained information relating to the target response; and enabling 37 the at least one filter to be applied to an audio signal to obtain the target response.

The computer program 9 may arrive at the apparatus 1 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), or an article of manufacture that tangibly embodies the computer program. The delivery mechanism may be a signal configured to reliably transfer the computer program 9. The apparatus may propagate or transmit the computer program 9 as a computer data signal. In some examples the computer program code 11 may be transmitted to the apparatus 1 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

Although the memory circuitry 7 is illustrated as a single component in the figures it is to be appreciated that it may be implemented as one or more separate components some or all of which may be integrated/removable and/or may provide permanent/semi-permanent/dynamic/cached storage.

Although the processing circuitry 5 is illustrated as a single component in the figures it is to be appreciated that it may be implemented as one or more separate components some or all of which may be integrated/removable.

References to “computer-readable storage medium”, “computer program product”, “tangibly embodied computer program” etc. or a “controller”, “computer”, “processor” etc. should be understood to encompass not only computers having different architectures such as single/multi-processor architectures, Reduced Instruction Set Computing (RISC) and sequential (Von Neumann)/parallel architectures but also specialized circuits such as field-programmable gate arrays (FPGA), application-specific integrated circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

FIG. 2 schematically illustrates an electronic device 21. The electronic device 21 comprises an apparatus 1 as described above. Corresponding reference numerals are used for corresponding features. In addition to the apparatus 1 the example electronic device 21 of FIG. 1 also comprises attachment means 23, at least one loudspeaker 25 and at least one microphone 27. It is to be appreciated that only features which are needed for the following description are illustrated in FIG. 2. The electronic device 21 may comprise other features which are not illustrated in FIG. 2 such as a transceiver, a power source or any other suitable features.

The electronic device 21 may be headphones which are configured to be worn by the user. The headphones could by any types of headphones, for examples it may be an inner ear headphone or a headset or any other suitable type of headphone. In such examples the attachment means 23 may comprise any means which enables the headphones to be worn by the user so that the loudspeaker and microphone are positioned adjacent to the ear canal of the user. For example, where the headphones are inner ear headphones the attachment means may comprise a portion shaped to fit in the ear of the user. Where the headphones are part of a headset the attachment means 23 may comprise a band which is worn on the head of the user or any other suitable means.

The loudspeaker 25 may provide a speaker element for the headphone. The loudspeaker 25 may comprise any means which may be configured to convert an electrical input signal to an acoustic output signal. The loudspeaker 25 may be positioned within the electronic device 21 so that, in use, the loudspeaker 25 is positioned adjacent to the ear canal of the user.

The microphone 27 may comprise any means which may be configured to acoustic input signal into an electrical output signal. The microphone 27 may be positioned within the electronic device 21 so that, in use, the microphone 27 is positioned adjacent to the ear canal of the user. In use, the microphone 27 may be provided within the ear of the user. The microphone 27 may be positioned adjacent to the loudspeaker 25. The microphone 27 may be positioned in close proximity to the loudspeaker 25.

In the example described above the electronic device 21 is a headphone. It is to be appreciated that the apparatus 1 could be provided in other types of electronic devices to enable the methods of the disclosure to be carried out. For instance, in some examples some or all of the blocks of the methods may be performed by a user device such as a mobile telephone or other portable electronic device. In such examples the electronic device 21 may comprises a transceiver to enable information to be exchanged between the headphone and the user devices. In some examples there may be a communication connection between the headphone and the electronic device. The connection could be a wired or wireless connection.

FIG. 3 illustrates a method. The example method may be implemented using an apparatus 1 and electronic device 21 as described above.

The method comprises at block 31, obtaining information relating to a measured response of a headphone wherein the response is measured when the headphone is positioned adjacent an ear canal of a user. The method also comprises, at block 33 obtaining information relating to a target response of the headphone wherein the target response replicates a different headphone. At block 35 the method comprises determining at least one filter using the measured response and the obtained information relating to the target response and at block 37 the method comprises enabling the at least one filter to be applied to an audio signal to obtain the target response.

FIG. 4 illustrates another method of determining at least one filter for headphones according to examples of the disclosure. The example method may also be implemented using apparatus 1 and electronic devices 21 as described above. In the example of FIG. 4 the microphone 27 and loudspeaker 25 are provided within an inner-ear type headphone. The microphone 27 may be provided in close proximity to the loudspeaker 25. It is to be appreciated that other types of headphones and electronic devices 21 may be used in other examples of the disclosure.

At block 41 the procedure is initiated. In some examples the procedure may be initiated automatically whenever the user turns on an electronic device 21 or turns on the audio functions of an electronic device 21. In such examples the procedure may be initiated automatically without any direct input from the user.

In other examples the procedure may be initiated in response to a user input. For instance, a user may actuate a button on a headset or may select an option in a headphone application of a mobile phone or other user device. In such examples the user may also be able to select the target response that they would like to obtain. For instance they may select a type of headphones that they would like to replicate the sound quality of or they may indicate a type of audio that they are listening to or any other factor which may affect the target response.

At block 42 a test signal is provided and an audio signal is recorded. The test signal may be provided when the user is wearing the headphones. When the user is wearing the headphones the loudspeaker 25 and the microphone 27 may be positioned adjacent to the ear canal 67 of the user.

The test signal may be an acoustic signal which may be provided by the loudspeaker 25. The test signal may be any suitable test signal such as a logarithmic sinusoidal sweep, a maximum length sequence (MLS) or any other suitable test signal. In some examples sinusoidal sweeps may be used as these may sound relatively pleasant compared to noise-like signals such as the MLS.

Any length of test signal may be used. In examples where the test signal is a logarithmic sinusoidal sweep, the measurement signal length can be as short as 200 ms.

In some examples the test signal may be provided to both the right ear of the user and the left ear of the user. In such examples the test signals may be provided sequentially, for instance the test signal may be provided to the right ear before it is provided to the left ear. This may enable a very accurate filter to be designed for each ear. In other examples the test signal might be provided to only one ear. In such examples it may be assumed that the response for the headphone in one ear is substantially the same as the response for the headphone in the other ear. This may reduce the processing required to obtain all the necessary information and/or to design the filters.

The microphone 27 is configured to record an audio signal simultaneously to the test signal being provided. The recorded audio signal may be stored in the memory circuitry 7 of the apparatus 1. The recorded audio signal may be used to determine the response of the headphone when it is worn by the user. The recorded audio signal may therefore comprise information relating to a measured response of a headphone wherein the response is measured when the headphone is positioned adjacent an ear canal 67 of a user

At block 43 the impulse response for the headphone is computed. The impulse response may be computed using any suitable technique and audio signal which has been recorded by the microphone 27. The impulse response may be computed by comparing the known test signal which was provided at block 43 with the audio signal which has been recorded by the microphone 27.

In some examples the impulse response may be computed by deconvolution of the known test signal and the recorded audio signal. In such examples the impulse response of the inner-ear headphone when it is positioned in the ear of the user is given by hᵢₑ_{_}ᵤₛₑᵣ where,

$${h}_{ie \_ user} = Re ( IFFT ( \frac{{Y}_{ie \_ user}}{{X}_{sweep}} ) ) ,$$

and where Yᵢₑ_{_}ᵤₛₑᵣ is the fast Fourier transform (FFT) of the audio signal which was recorded by the microphone 27 at block 42 and X_{sweep} is the FFT of the test signal which was provided by the loudspeaker 25. In this example the test signal was a sinusoidal sweep. In other examples, other transforms of the audio signal may be used, for instance a wavelet transform or any other suitable type of transform could be used.

After the impulse response hᵢₑ_{_}ᵤₛₑᵣ has been computed, it may be truncated to reduce the number of data points. In some examples the response may be truncated by finding the index for the maximum absolute value of the response and retaining a predetermined number of samples either side of the maximum absolute values.

For instance in some examples the impulse response could be trimmed to 10 samples before the maximum absolute value 120 samples after the maximum absolute value. In this example, the trimmed response length would be 131 samples. At a sampling frequency of 44100 Hz, this corresponds to approximately 3 ms. It is to be appreciated that any number of samples could be used in other examples and implementations of the disclosure.

At block 44 a set of quality parameters are computed. The impulse response computed at block 43 may be used to compute the quality parameters. The quality parameters may comprise any metric which may be used to quantify the quality of the impulse response. This may provide a measure of how well the earphone fits in the user's ear. The quality parameters may comprise the amount of bass in the spectrum of the impulse response, the number of significant peaks in the spectrum of the impulse response, the value of the leakage parameter or any other suitable parameter. The quality parameters may be computed using any suitable technique.

In some examples the amount of bass in the spectrum of the impulse response may be computed by obtaining a normalized magnitude spectrum of the measured response of the headphone and comparing this with the normalized magnitude spectrum of a response of a dummy head. The response of the dummy head may be obtained by using the same headphones with the same microphone 27 positioned adjacent to a dummy head. In some examples the average difference between the normalized spectrums may be compared. The normalized magnitude spectrums may be compared within certain frequency ranges such as 0-100 Hz or 0-200 Hz or any other suitable range.

As an example the amount of bass in the spectrum of the impulse response may be computed by zero-padding the measured response of the headphone and the response of a dummy head. For instance zeros may be added to the end of the response so that the total length may be 6000 samples, or any other number. FFTs may then be computed from the zero-padded responses. The magnitude spectra of the measured headphone response and the response of the dummy head are normalized so that they have the same energy at 1 kHz.

The average difference D of the magnitude spectra in decibels may then computed as

$$D = \frac{1}{{k}_{high} - {k}_{low} + 1} {\sum }_{k = {k}_{low}}^{{k}_{high}} ( 20 * {log}_{10} \vert {H}_{ie \_ dummy} [ k ] \vert - 20 * {log}_{10} \vert {H}_{ie \_ user , norm} [ k ] \vert ) ,$$

where k_{low} and k_{high} are the frequency bin indices corresponding to the lower and upper limit of the frequency band of interest, Hᵢₑ_{_}_{dummy}[k] is the frequency response of the dummy head, and Hᵢₑ_{_}_{user,norm}[k] is the normalized frequency response of the measured in-ear impulse response.

It is to be appreciated that other values could be computed instead of, or in addition to, the mean value. For instance, in some examples the maximum of the difference between the spectrums could be computed instead of the mean. The maximum difference may provide a stricter criterion for a bass quality parameter because this would provide a higher limit for the difference that cannot be exceeded for any frequency bin in the frequency band of interest.

FIGS. 5A and 5B illustrate example spectra obtained from dummy heads and a user as described above. The plots of FIGS. 5A and 5B show example spectra measured from a headphone positioned adjacent to a dummy head (Hᵢₑ_{_}_{dummy}[k]) compared to a headphone positioned adjacent to a user (Hᵢₑ_{_}_{user,norm}[k]).

The example of FIG. 5A illustrates a case where there is not enough bass in the measured response of the headphone being used by the user. In this particular example the mean bass difference between 0-100 Hz is 7.55 dB. The deviation between the response obtained from the user and the response obtained from the dummy can be easily seen in the plot of FIG. 5A.

The example of FIG. 5B illustrates a case where there is enough bass in the measured response of the headphone being used by the user. In this particular example the mean bass difference between 0-100 Hz is 1.16 dB. The deviation between the response obtained from the user and the response obtained from the dummy is much smaller in the plot of FIG. 5B.

In some examples the number of significant peaks Nₚ in the spectrum of the spectrum of the impulse response obtained at block 43 may be computed by the finding the number of significant peaks within the logarithmic frequency spectrum. In some examples the number of significant peaks within a predetermined frequency range may be determined. The predetermined frequency range may correspond to the audible frequency range. In some examples the frequency range could be 20-10000 Hz or any other suitable range.

In some examples the number of significant peaks Nₚ in the spectrum of the impulse response may be computed by using a zero-padded FFT, as described above, and using a peak picking algorithm to identify significant peaks within the spectrum. Any suitable peak picking algorithm may be used.

The leakage parameter may give an indication of how well the headphone fits the user's head. The leakage parameter may be computed using any suitable algorithm such as the Goertzel algorithm. In order to apply an algorithm such as the Goertzel algorithm the measured response of the headphone may be zero-padded to a predetermined length. For instance, in some examples the response may be padded to a length of 1000 samples, or any other suitable number. The Goertzel algorithm is then computed for a small number of selected frequencies. For instance the Goertzel algorithm may be computed for the frequencies 125 Hz, 170 Hz, 200 Hz, and 3000 Hz. The leakage value L is then computed as

$$L = \frac{{\sum }_{i = 1}^{N - 1} {G}_{i}}{N - 1} - {G}_{N} ,$$

where Gᵢ are the results of Goertzel algorithm (in dB) for frequency point with index i starting from the lowest frequency component. In this illustrative example i=1 corresponds to the frequency of 125 Hz. N is the total number of frequency components. In this illustrative example N=4. In this example if the computed leakage value L is large this indicates that there is a tight fit and a small amount of leakage. Conversely if the computed leakage value L is small this indicates that the headphone does not fit well and there is a significant amount of leakage.

It is to be appreciated that the methods described for computing the quality parameters are provided for illustrative purposes and that other methods and algorithms may be used in other examples of the disclosure. It also to be appreciated that other types of quality parameters may be computed in other examples of the disclosure.

At block 45 it is determined whether or not the measured impulse response is good enough to be used to determine one or more filters. In some examples this may be achieved by comparing the quality parameters obtained at block 44 with predetermined thresholds to determine the quality of the measured response.

In the examples where the quality factors which have been computed comprise average difference D of the magnitude spectra, number of significant peaks Nₚ in the spectrum of the impulse response and leakage value L then, at block 45 it will be determined whether these values are above or below predetermined thresholds. In some examples the measured impulse response may be determined to have sufficient quality if

(D<T_{D}) [symbol] (Nₚ<T_{N}_{ₚ}) [symbol] (L>T_{L,min}) [symbol] (L<T_{L,max}),

where T_{D} is the upper threshold for bass difference measure, T_{N}_{ₚ} is the upper threshold for the number of spectral peaks, T_{L,min} is the lower threshold for the leakage value, and T_{L,max} is the upper threshold for the leakage value.

An upper threshold for the leakage may be advantageous to include as a very high leakage parameter value indicates a tight fit of the headphone but often results from a corrupted measurement, for instance if there is a significant amount of noise.

As an example values for the thresholds could be T_{D}=3 dB, T_{N}_{ₚ}=3, T_{L,min}=−3, and T_{L,max}=1. It is to be appreciated that other values could be used in other examples of the disclosure.

If the threshold conditions are not fulfilled, then impulse response is measured again by returning to block 42 and repeating the test signal and the recording of the response.

At block 46 headphone simulation filters are determined. One or more filters may be determined to simulate the response of a predetermined set of headphones.

The filters may be designed using the transfer function of the impulse response of the inner-ear headphone when it is positioned in the ear of the user Hᵢₑ_{_}ᵤₛₑᵣ. The transfer function Hᵢₑ_{_}ᵤₛₑᵣ is the previously measured impulse response hᵢₑ_{_}ᵤₛₑᵣ represented in frequency domain.

The filters may also be designed using information relating to the response of the user's ear canal. In the example of FIG. 4 the information relating to the response of the user's ear canal may be obtained from a simulation ear canal such as a HATS (head and torso simulator) dummy head.

An example of a HATS dummy head is schematically illustrated in FIG. 6A The HATS dummy head may comprise a microphone 61 positioned adjacent to the ear drum 63. The microphone 63 is positioned at the drum reference point (DRP) within the ear canal 65 of the dummy head.

The information relating to the response of the user's ear canal, which is used to design the filters, may comprise a pre-computed response transfer function H_{DRP}_{_}_{dummy} between the in-ear microphone 27 close to the headphone loudspeaker and the microphone 63 close to the ear drum 63. This information may be stored in the memory circuitry 7 of the apparatus 1 and may be retrieved when the filters are to be designed. The dummy head response may be close enough to the actual response of the user's ear canal to enable accurate filters to be designed. An example of a real user's head is schematically illustrated in FIG. 6B.

The filters may also be designed using information relating to a target response of the headphone and ear canal. This information may comprise pre-measured target headphone transfer functions. The pre-measured target headphone transfer functions may be measured at the drum reference point of the dummy head using the headphones which are to be simulated. The target headphone transfer functions may be given by H_{target,i}, where i is the index of the target headphone. This may allow different headphones to be simulated. This information may be stored in the memory circuitry 7 of the apparatus 1 and may be retrieved when the filters are to be designed.

The pre-computed response transfer function H_{DRP}_{_}_{dummy} is computed as;

$${H}_{DRP \_ dummy} = \frac{{H}_{ed \_ dummy}}{{H}_{ie \_ dummy}} ,$$

where H_{ed}_{_}_{dummy} is the measured transfer function of the dummy head at the microphone 63 in the ear canal 65 and Hᵢₑ_{_}_{dummy} is the measured transfer function of the dummy head at microphone 27 within the headphone.

It is assumed that the transfer function of the dummy head will be similar to that of the user. The transfer function Ĥ_{ed}_{_}ᵤₛₑᵣ at the user's real ear-drum location, as illustrated in FIG. 6B, is then estimated as

Ĥ_{ed}_{_}ᵤₛₑᵣ=Hᵢₑ_{_}ᵤₛₑᵣ·H_{DRP}_{_}_{dummy}.

The assumption in this example is that H_{DRP}_{_}_{dummy} corresponds well enough to its counterpart in the ear canal of the user.

The corresponding time-domain response ĥ_{ed}_{_}ᵤₛₑᵣ is computed as

ĥ_{ed}_{_}ᵤₛₑᵣ=Re(IFFT(Ĥ_{ed}_{_}ᵤₛₑᵣ)),

where IFFT is an inverse fast Fourier transform. In other examples the time domain response ĥ_{ed}_{_}ᵤₛₑᵣ may be computed directly in the time domain as a convolution between hᵢₑ_{_}ᵤₛₑᵣ and h_{DRP}_{_}_{dummy}.

The information relating to a target response of the headphone and ear canal may be normalized. The target transfer functions H_{target,i} may be normalized so that they have the same energy at the 1 kHZ region as Ĥ_{ed}_{_}ᵤₛₑᵣ.

This normalization may be performed using any suitable technique. In some examples the normalization may be performed by computing a gain factor gᵢ for each target response where gᵢ is given by

$${g}_{i} = \frac{{\sum }_{k = {k}_{g , low}}^{{k}_{g , high}} \vert {\hat{H}}_{ed \_ user} [ k ] \vert}{{\sum }_{k = {k}_{g , low}}^{{k}_{g , high}} \vert {H}_{target , i} [ k ] \vert} ,$$

where k_{g,low} and k_{g,high} denote the frequency range for computing the sum of the absolute values. For instance k_{g,low}=43 and k_{g,high}=53, corresponds to 900-1100 at a sampling frequency of 44100 Hz, when Ĥ_{ed}_{_}ᵤₛₑᵣ and H_{target,i} have been computed at 1024 frequency points within the upper half of the unit circle, that is, with a FFT of 2048 points length.

The gain factors gᵢ are then used to multiply the time-domain responses corresponding to each target response H_{target,i} prior to FFT and deconvolution. This may be similar to the normalization that is used to compute the mean bass differences as described above. In that example, the gain gᵢₑ_{ᵤₛₑᵣ} may be computed as

$${g}_{{ie}_{user}} = \frac{{\sum }_{k = {k}_{g , low}}^{{k}_{g , high}} \vert {H}_{{ie}_{dummy}} [ k ] \vert}{{\sum }_{k = {k}_{g , low}}^{{k}_{g , high}} \vert {H}_{ie \_ user} [ k ] \vert}$$

After the information relating to a target response of the headphone and ear canal has been normalized the headphone simulation filters may be obtained using any suitable method such as deconvolution.

In order to obtain the filters by deconvolution a FFT is taken of the normalized target responses as

H_{target,deconv,i}=FFT(gᵢ·h_{target,i})

where gᵢ is the gain factor for target response i computed above.

Then, an FFT is taken of the estimated transfer function ĥ_{ed}_{_}ᵤₛₑᵣ at the user's ear drum location as

Ĥ_{ed}_{ᵤₛₑᵣ}_{,deconv}=FFT(ĥ_{ed}_{ᵤₛₑᵣ})

The FFT length N_{FFT,deconv} used for moving to the frequency domain for deconvolution is the sum of the two time domain filter lengths plus one, i.e., lengths of h_{target,i} and ĥ_{ed}_{_}ᵤₛₑᵣ plus one.

Frequencies of the normalized target responses H_{target,deconv,i} within a given range may be given higher weightings than other frequencies within other ranges. This may reduce the processing capacity needed while still providing accurate results. In the current example frequencies above 10 kHz may be de-emphasized, because they are not important perceptually and would waste modeling power of the filter.

FIG. 7 illustrates an example target weighting function (solid line) that may be used to ensure that higher weightings are given to frequencies below 10 KHz. In the particular example weighting function of FIG. 7 frequencies of the normalized target responses H_{target,deconv,i} below 8 kHz are given full weight and frequencies above 12 kHz have zero weight. The frequency range 8-12 kHz acts as a transition band. In the example of FIG. 7 the weighting function has a half-cosine ramp within this range.

The inverse of this target weighting function is an estimated ear drum response weighting function. This is given by the dashed line in FIG. 7. The estimated ear drum response weighting function is used to weigh the estimated ear drum response to ensure that the resulting equalization has a flat 0 dB magnitude response above 12 kHz.

The example weighting functions may also be used to weigh negative frequencies in the FFT. In such examples the weighting function may be flipped from left to right about the y axis to arrive at the complete weighting function w[k].

The phase may be set to zero prior to moving to the time domain via IFFT. The time-domain FIR (finite impulse response) filters h_{eq,i}[n] are therefore obtained as

$${h}_{eq , i} [ n ] = Re ( \frac{1}{{N}_{FFT , dc}} {\sum }_{k = 0}^{{N}_{FFT , deconv} - 1} ( \frac{\begin{matrix}w [ k ] \cdot \vert {H}_{target , deconv , i} [ k ] \vert + \\ ( 1 - w [ k ] ) \cdot \vert {\hat{H}}_{ed \_ user , deconvc} [ k ] \vert\end{matrix}}{\vert {\hat{H}}_{ed \_ user , deconv} [ k ] \vert} \cdot {e}^{i2 π k n \text{/} {N}_{FFT , deconv}} ) )$$

As a final step after deconvolution and returning to the time domain, the resulting FIR responses h_{eq,i} may be made minimal phase by computing the minimum phase reconstruction via the real cepstrum.

At block 47 the at least one filter may be applied to the audio that the user is listening to. The determined filters may be stored in the memory circuitry 7 to enable the filters to be applied to the audio.

Blocks 41 to 46 of the method of FIG. 4 provide a method of calibrating a set of headphones. In some examples the headphones may be calibrated every time the user wears the head phones. In such examples the measurement of the headphone response may be obtained every time the user wears the headphones. This may allow for a more accurate system as any changes in the position of the headphone within the ear may affect the measured response of the headphone.

In some examples once the headphones have been calibrated the information which has been obtained may be stored in memory circuitry. In some examples the measured response of the headphone may be stored in the memory circuitry. This same information can be used to calculate different filters. For example if the user wishes to replicate the sound quality of a different pair of headphones this will require a different set of filters to be designed. However the new set of filters could be designed using the measured response of the headphone which has been stored in the memory circuitry. This may enable different target responses to be obtained quickly and with minimal processing.

In some examples the minimum phase equalization filters h_{eq,mp,i} may be stored in the memory circuitry 7. This may enable the filters to be applied without having to recalibrate the headphones. In some examples the frequency responses of the filters H_{eq,mp,i} may also be stored in the memory circuitry 7.

In some examples the filters h_{eq,mp,i} may be truncated to a predetermined filter length. This may reduce the computational load. For instance, in some examples the filter length may be reduced to 100 taps or any other suitable length. In some examples the filters, or the impulse response, may be warped before the filters are truncated. This may enable a more computationally efficient filter to be obtained. It is to be appreciated that there is a trade-off between computational load gains and filtering accuracy. If the filter order is too low, the result does not sound the same as the original filter.

In other examples other techniques may be used to reduce the computational loads of the filters. For example, frequency-domain FIR filtering may be used or any other suitable technique.

FIG. 8 shows another example method which may be used in examples of the disclosure. The example method may be implemented using an apparatus 1 and electronic device 21 as described above.

At block 81 a user may selected a desired target response for the headphones that they are using. In some examples a user may select a desired target response by selecting a type of headphone from a menu or other user interface item. In some examples the menu may be presented on a user device. The selected target response may then simulate the selected headphone.

In other examples the user may select a target response by selecting some other characteristic such as the type of audio they are listening to or any other suitable factor.

At block 83 the filters corresponding to the user's selection are applied to the audio output. In some examples the filters may be computed as described above. In other examples the filters may have be computed earlier and may have been stored in the memory circuitry 7. In such examples the filters may be retrieved from the memory circuitry 7.

The example methods and apparatus described above make it possible for a first pair of headphones to sound like different, second pair of headphones. This enables the user to obtain the sound quality of the second pair of headphones while they are wearing the first pair.

This may be used to enable less expensive headphones to sound very similar to more expensive headphones. It may also enable the settings of the headphones to be adjusted for the type of audio that the user is listening too. For instance the target response of the headphone may be adjusted based on whether the user is listening to pop, rock or classical music or any other type of audio.

Examples of the disclosure may also improve the user experience of the headphones as it enables equalization of the headphone based on actual measurements of the headphone response rather than a generic setting.

The blocks illustrated in the FIGS. 3, 4 and 8 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
obtaining information relating to a measured response of a headphone wherein the response is measured when the headphone is positioned adjacent an ear canal of a user;
computing at least one quality parameter wherein the at least one quality parameter provides a measure of how well the headphones fits the user's ears;
obtaining information relating to a target response of the headphone wherein the target response replicates a different headphone;
determining at least one filter using the measured response and the obtained information relating to the target response; and
enabling the at least one filter to be applied to an audio signal to obtain the target response.

2. A method as claimed in claim 1, further comprising providing a microphone within the headphone to enable the response of the headphone to be measured.

3. A method as claimed in claim 2, wherein the microphone is adjacent to a speaker element within the headphone.

4. A method as claimed in claim 2, where the response of the headphone is measured by providing a test signal from the headphone speaker element and using the microphone to record the response.

5. A method as claimed in claim 2 wherein the response of the headphone is measured whenever the headphone is used to enable the filters to be designed.

6. A method as claimed in claim 2, further comprising:
storing the measured response in memory circuitry; and
retrieving the measured response from the memory circuitry to enable the at least one filter to be determined.

7. A method as claimed in claim 1, wherein information relating to the response of the user's ear canal is obtained using a simulation ear canal.

8. A method as claimed in claim 1, further comprising storing the at least one determined filter.

9. A method as claimed in claim 1, wherein the at least one quality parameter comprises at least one of the amount of bass in a spectrum of an impulse response, the number of significant peaks in the spectrum of the impulse response, and the value of a leakage parameter.

10. A method as claimed in claim 9, wherein the at least one quality parameter is compared with a predetermined threshold to determine the quality of the measured response.

11. An apparatus comprising:
processing circuitry; and
memory circuitry including computer program code, the memory circuitry and the computer program code configured to, with the processing circuitry, enable the apparatus to perform;
obtaining information relating to a measured response of a headphone wherein the response is measured when the headphone is positioned adjacent an ear canal of a user;
computing at least one quality parameter wherein the at least one quality parameter provide a measure of how well the headphones fits the user's ears;
obtaining information relating to a target response of the headphone wherein the target response replicates a different headphone;
determining at least one filter using the measured response and the obtained information relating to the target response; and
enabling the at least one filter to be applied to an audio signal to obtain the target response.

12. An apparatus as claimed in claim 11, further comprising a microphone within the headphone configured to enable the response of the headphone to be measured.

13. An apparatus as claimed in claim 12, wherein the microphone is adjacent to a speaker element within the headphone.

14. An apparatus as claimed in claim 12, where the response of the headphone is measured by providing a test signal from the headphone speaker element and using the microphone to record the response.

15. An apparatus as claimed in claim 12, wherein the response of the headphone is measured whenever the headphone is used to enable the filters to be designed.

16. An apparatus as claimed in claim 12, wherein the measured response is stored in memory circuitry and retrieved from the memory circuitry to enable the filters to be designed.

17. An apparatus as claimed in claim 11, wherein information relating to the response of the user's ear canal is obtained using a simulation ear canal.

18. An apparatus as claimed in claim 11, wherein the apparatus is further configured to store the at least one determined filter.

19. An apparatus as claimed in claim 11, wherein the at least one quality parameter comprises at least one of the amount of bass in a spectrum of an impulse response, the number of significant peaks in the spectrum of the impulse response, the value of a leakage parameter.

20. A non-transitory physical entity comprising a computer program comprising computer program instructions that, when executed by processing circuitry, enable:
obtaining information relating to a measured response of a headphone wherein the response is measured when the headphone is positioned adjacent an ear canal of a user;
obtaining information relating to a target response of the headphone wherein the target response replicates a different headphone;
computing at least one quality parameter wherein the at least one quality parameter provide a measure of how well the headphones fits the user's ears;
determining at least one filter using the measured response and the obtained information relating to the target response; and
enabling the at least one filter to be applied to an audio signal to obtain the target response.
